(19) United States
(12) Patent Application Publication
(10) Pub. No.: US 2026/0131808 A1
(43) Pub. Date: May 14, 2026

(54) APPARATUS, METHOD AND STORAGE MEDIUM FOR PREVENTING ERRONEOUS OPERATION OF AN ACCELERATOR PEDAL, AND A VEHICLE INCLUDING THE SAME

(71) Applicants: HYUNDAI MOTOR COMPANY, Seoul (KR); KIA CORPORATION, Seoul (KR)

(72) Inventor: Sung Hwan Jang, Hwaseong-si (KR)

(73) Assignees: HYUNDAI MOTOR COMPANY, Seoul (KR); KIA CORPORATION, Seoul (KR)

(21) Appl. No.: 19/196,567

(22) Filed: May 1, 2025

(30) Foreign Application Priority Data
Nov. 14, 2024 (KR) 10-2024-0162295

(51) Int. Cl. B60W 50/10

(52) U.S. Cl. CPC B60W 50/10; B60W 2520/10; B60W 2540/10; B60W 2540/12; B60W 2710/18; B60W 2720/106

(57) ABSTRACT

An apparatus for preventing erroneous operation of an accelerator pedal includes an accelerator pedal sensor configured to sense an accelerator pedal effort of a vehicle. The apparatus also includes a controller configured to selectively block acceleration torque of the vehicle based on determining whether the accelerator pedal effort sensed by the accelerator pedal sensor satisfies an over-effort condition in which the accelerator pedal effort sensed by the accelerator pedal sensor is higher than a first reference value. The apparatus further includes a buffer configured to vary contact with the acceleration pedal based on a value relationship between a second reference value, which is lower than the first reference value, and the accelerator pedal effort. The buffer is configured to buffer in response to contact with the accelerator pedal.

### CROSS-REFERENCE TO RELATED APPLICATION(S)

This application claims the benefit of and priority to Korean Patent Application No. 10-2024-0162295 filed on Nov. 14, 2024, the entire contents of which are hereby incorporated herein by reference.

### BACKGROUND

### 1. Technical Field

The present disclosure relates to an apparatus, a method, and a storage medium for preventing erroneous operation of an accelerator pedal, and a vehicle including the same.

### 2. Description of Related Art

Recently, as the number of traffic accidents caused by elderly drivers has increased due to the aging population phenomenon, major countries have established policies to strengthen physical and aptitude tests for elderly drivers or to place restrictions on driver's licenses.

In general, as elderly people age, their physical structure and visual and auditory cognitive abilities deteriorate, resulting in poor judgment, decreased concentration, and slow reaction speeds, which increases the risk of accidents while driving. Elderly drivers may develop neurological diseases, such as dementia, Parkinson's disease, and stroke without their own knowledge, and the fatality rate is high when accidents occur due to these diseases. For example, many traffic accidents caused by elderly drivers are due to an erroneous operation of an accelerator pedal when a brake pedal should be pressed, and in many cases, elderly drivers momentarily may lose the sense of direction and drive a vehicle on a sidewalk instead of on a roadway or drive a vehicle in the opposite direction to traffic.

In addition, since automatic transmission vehicles do not have a clutch pedal, a brake pedal is installed to one side of an accelerator pedal, and inexperienced drivers, elderly drivers, or even experienced drivers often operate the accelerator pedal and brake pedal simultaneously or mistakenly operate the accelerator pedal as the brake pedal when braking suddenly in an emergency situation, and as a result, the vehicle may rapidly accelerate instead of braking suddenly, which increases the material and human damage caused by the accident.

The statements in this Background section merely provide background information related to the present disclosure and may not constitute prior art.

### SUMMARY

Embodiments of the present disclosure provide an apparatus, method, and storage medium for preventing erroneous operation of an accelerator pedal, and a vehicle including the same, capable of more stably securing the accuracy of determining an erroneous operation of an accelerator pedal and stably reducing the possibility of sudden acceleration of a vehicle.

According to an aspect of the present disclosure, an apparatus for preventing erroneous operation of an accelerator pedal is provided. The apparatus includes an accelerator pedal sensor configured to sense an accelerator pedal effort of a vehicle. The apparatus also includes a controller configured to selectively block acceleration torque of the vehicle based on determining whether the accelerator pedal effort sensed by the accelerator pedal sensor satisfies an over-effort condition in which the accelerator pedal effort sensed by the accelerator pedal sensor is higher than a first reference value. The apparatus additionally includes a buffer configured to vary contact the acceleration pedal based on a value relationship between a second reference value, which is lower than the first reference value, and the accelerator pedal effort. The buffer is configured to buffer in response to contact with the accelerator pedal.

The buffer may be configured to provide elastic force in response to contact with the accelerator pedal.

The apparatus may further include a stopper including the buffer and a coupler, coupled to the buffer. The coupler may be less elastic tan the buffer.

The buffer may be disposed so that the second reference value corresponds to a maximum acceleration of the accelerator pedal.

The accelerator pedal may include a pedal arm and a pedal pad connected to an end of the pedal arm. The buffer may be disposed to contact the pedal arm when the accelerator pedal effort is greater than or equal to the second reference value.

The controller may release or deactivate the acceleration torque blocking control according to the accelerator pedal effort based on determining that a number of times of that the accelerator pedal effort is higher than the first reference value is less than a predetermined number of times within a predetermined period of time.

The controller may release or deactivate the acceleration torque blocking control according to the accelerator pedal effort based on determining that a brake switch of the vehicle is in an ON state.

The controller may release or deactivate the acceleration torque blocking control according to the accelerator pedal effort based on determining that a vehicle speed of the vehicle is lower than a reference vehicle speed.

The controller, after blocking the acceleration torque according to the accelerator pedal effort, may release the acceleration torque blocking control according to the accelerator pedal effort based on determining that i) a first release condition that the accelerator pedal effort is less than the first reference value and ii) a second release condition that a brake switch of the vehicle is in an ON state or a vehicle speed of the vehicle is lower than a reference vehicle speed are satisfied.

The controller may operate an anti-lock braking system (ABS) of the vehicle when the acceleration torque is blocked according to the accelerator pedal effort.

According to another aspect of the present disclosure, a method for preventing erroneous operation of an accelerator pedal is provided. The apparatus includes receiving an accelerator pedal signal from an accelerator pedal sensor and determining a number of over-effort conditions in which the accelerator pedal signal exceeds an effort corresponding to a maximum acceleration of an accelerator pedal within a predetermined period of time. The method also includes selectively controlling a vehicle to block acceleration torque of the vehicle when the number of over-effort conditions is equal to or greater than a predetermined number of times within the predetermined period of time.

The method may further include, after controlling the vehicle to block acceleration torque of the vehicle, releasing the acceleration torque blocking control based on determining that i) a first release condition in which the accelerator pedal signal corresponds to an effort corresponding to a maximum acceleration of the accelerator pedal and ii) a second release condition that a brake switch of the vehicle is in an ON state or when a vehicle speed of the vehicle is lower than a reference vehicle speed are satisfied.

Controlling the vehicle to block acceleration torque of the vehicle may include deactivating the acceleration torque blocking control based on the controlling when the brake switch of the vehicle is in the ON state.

Controlling the vehicle to block acceleration torque of the vehicle may include deactivating the acceleration torque blocking control based on the controlling when the vehicle speed of the vehicle is lower than a reference vehicle speed.

Controlling the vehicle to block acceleration torque of the vehicle may include operating an anti-lock braking system (ABS) of the vehicle when the number of over-effort conditions is equal to or greater than a predetermined number of times (e.g., a plurality of times) within a predetermined period of time.

According to another aspect of the present disclosure, a vehicle includes the apparatus for preventing erroneous operation of an accelerator pedal described above.

According to another aspect of the present disclosure, a storage medium may record one or more programs including instructions for executing the method for preventing erroneous operation of an accelerator pedal described above.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a diagram illustrating an erroneous operation of an accelerator pedal according to an embodiment of the present disclosure;

FIG. 2 is a flowchart illustrating a method for preventing erroneous operation of an accelerator pedal according to an embodiment of the present disclosure;

FIG. 3 is a graph illustrating a value relationship between an accelerator pedal signal of an accelerator pedal sensor and an accelerator pedal opening of an accelerator pedal according to an embodiment of the present disclosure;

FIG. 4 is a diagram illustrating a stopper including a buffer of an apparatus for preventing erroneous operation of an accelerator pedal according to an embodiment of the present disclosure; and

FIG. 5 is a flowchart illustrating an apparatus and method for preventing erroneous operation of an accelerator pedal according to an embodiment of the present disclosure.

### DETAILED DESCRIPTION

While the present disclosure may be modified in various ways and take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It should be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe embodiments of the present disclosure are not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It should be further understood that the terms “comprise,” “comprising,” “include,” “including,” and the like, when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

When a controller, module, component, device, element, or the like of the present disclosure is described as having a purpose or performing an operation, function, or the like, the controller, module, component, device, element, or the like should be considered herein as being “configured to” meet that purpose or to perform that operation or function.

In this specification, vehicles refer to a variety of vehicles that move transported objects, such as people, animals, or goods, from a starting point to a destination. These vehicles are not limited to vehicles that run on roads or tracks.

Hereinafter, embodiments of the present disclosure are described with reference to the accompanying drawings.

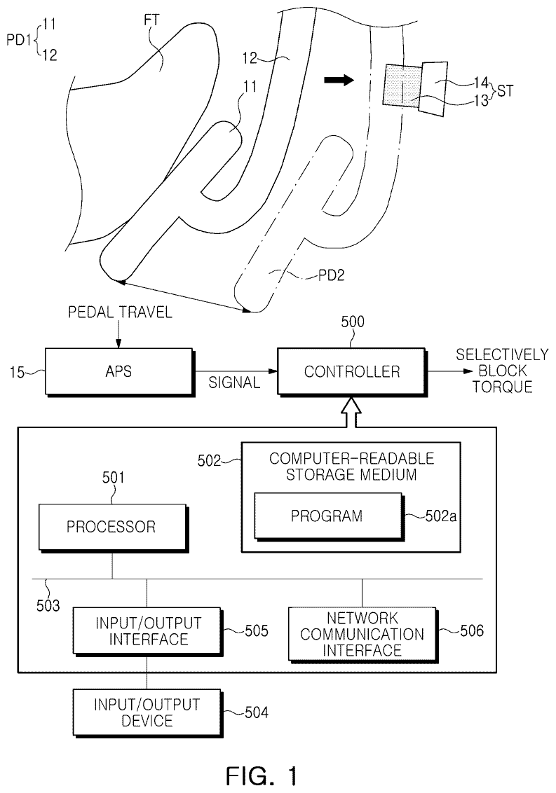

FIG. 1 is a diagram illustrating an apparatus for preventing erroneous operation of an accelerator pedal according to an embodiment of the present disclosure. Referring to FIG. 1, the apparatus for preventing erroneous operation of an accelerator pedal according to an embodiment of the present disclosure may include an accelerator pedal sensor (APS) 15, a controller 500, and a buffer or buffer portion 13.

The accelerator pedal sensor 15 may be configured to sense a pressing force of the vehicle's acceleration pedal (referred to as “an accelerator pedal effort”). The accelerator pedal sensor 15 may be configured to measure the force applied by a driver's foot (FT) when pressing down the accelerator pedal (PD1 and PD2), but the present disclosure is not limited thereto. For example, the accelerator pedal sensor 15 may be configured to directly measure a distance (PEDAL TRAVEL) over which the vehicle moves as the driver's foot (FT) presses down the accelerator pedal or to measure whether positions of the accelerator pedal pass a specific position. The accelerator pedal “PD1” represents the pedal in a non-contact state with a buffer, while the “PD2” represents the pedal in contact with the buffer.

The controller 500 may be configured to determine whether an accelerator pedal effort sensed by the accelerator pedal sensor 15 satisfies an over-effort condition (sometimes referred to herein as simply “over-effort”) in which the accelerator pedal effort sensed by the accelerator pedal sensor 15 is higher than a first reference value, and if the accelerator pedal effort is an over-effort, the controller 500 may be configured to selectively block acceleration torque of the vehicle. For example, in the case of over-effort, the controller 500 may cut off fuel supply to an internal combustion engine, such as an engine (e.g., forcibly blocking a throttle of the engine) and/or cut off electric energy supplied to an electric energy power source, such as a motor (e.g., forcibly stopping a switching operation of an inverter of the motor). For example, the controller 500 may be implemented as an electronic control unit (ECU).

A situation in which the driver is likely to erroneously operate the accelerator pedal may include an emergency situation in which the driver has to step on the brake pedal urgently (e.g., a situation in which a vehicle speed is too fast or a distance to a front obstacle is too close at the time when the driver recognizes the front obstacle). In the above emergency situation, the driver may try to apply a greater force (over-effort) than the force with which the accelerator pedal (PD1, PD2) is normally pressed to the brake pedal, and may apply an over-effort to the accelerator pedal (PD1, PD2) by mistaking the accelerator pedal for the brake pedal. In other words, the driver may exert excessive force on the accelerator pedal (PD1, PD2) due to mistakenly pressing it instead of the brake pedal. As a result, the vehicle may accelerate suddenly.

The over-effort, which is higher than the first reference value of the accelerator pedal effort sensed by the accelerator pedal sensor 15, may correspond to a force greater than the force with which the driver normally presses the accelerator pedal (PD1, PD2). Therefore, the controller 500 may block the acceleration torque of the vehicle in the case of over-effort, thereby nullifying the driver's erroneous operation of accelerator pedal in which the driver mistakes the accelerator pedal (PD1, PD2) for a brake pedal and applies an over-effort to the accelerator pedal (PD1, PD2), and reducing the possibility of sudden acceleration of the vehicle.

The controller 500 may set the first reference value to be higher than the accelerator pedal effort corresponding to the force with which the driver normally presses the accelerator pedal (PD1, PD2). For example, the controller 500 may store the first reference value determined before being assembled into the vehicle or may update the first reference value based on the driver's driving history of the vehicle. For example, if the driver normally has a weak force with which he or she presses the accelerator pedal (e.g., a female driver or an elderly driver), the controller 500 may lower the first reference value from an initial first reference value based on a low accelerator pedal effort accumulated from the accelerator pedal sensor 15. As another example, if the driver normally has a strong force with which he or she presses the accelerator pedal (e.g., a young male driver), the controller 500 may increase the first reference value from the initial first reference value based on a high accelerator pedal effort accumulated from the accelerator pedal sensor 15. The first reference value may be a constant, but depending on the design, the first reference value may also be a function (e.g., a function in which the force with which the driver normally presses the accelerator pedal is an input variable).

As a difference between the accelerator pedal effort corresponding to the force with which the driver normally presses the accelerator pedal (PD1, PD2) and the first reference value is small or as the sensing accuracy of the accelerator pedal sensor 15 is lowered, the frequency at which the controller 500 blocks the acceleration torque of the vehicle based on over-effort may increase. If the frequency is too high, in a situation in which the driver normally recognizes the accelerator pedal (PD1 and PD2) but accidentally applies a slightly greater force to the accelerator pedal than usual, the possibility that the controller 500 mistakes it as an accelerator pedal erroneous operation may increase.

Since the accelerator pedal sensor 15 may be optimized for measuring the driver's acceleration intention to accelerate, the sensing of an over-effort (i.e., an excessive pressing force) higher than an effort corresponding to the maximum acceleration (e.g., 100% throttle opening of the engine) of the accelerator pedal may become saturated (or may be out of a sensing range). As a result, the sensing accuracy of the accelerator pedal sensor 15 for the over-effort may be difficult to secure. As the first reference value increases, it may be more difficult to secure the sensing accuracy of the accelerator pedal sensor 15.

The buffer 13 may be disposed so that whether the buffer 13 contacts the accelerator pedal (PD1: No contact, PD2: Contact) varies depending on the relationship between a second reference value lower than the first reference value and the accelerator pedal effort. The buffer 13 may be configured to buffer in response to the contact of the accelerator pedal PD1, PD2. Since the first reference value is higher than the second reference value that starts contact with the accelerator pedal PD2, the buffer 13 may buffer against over-effort corresponding to the first reference value or higher. For example, the buffer 13 may be disposed so that the second reference value (a contact start value between the buffer and the accelerator pedal) corresponds to the maximum acceleration of the accelerator pedal (e.g., 100% throttle opening of the engine).

Accordingly, a sensing saturation phenomenon (or sensing range departure phenomenon) of the accelerator pedal sensor 15 for the over-effort may be reduced, and the sensing accuracy of the accelerator pedal sensor 15 for over-effort may be efficiently secured. Therefore, the apparatus for preventing erroneous operation of an accelerator pedal according to an embodiment of the present disclosure may more stably secure the accuracy of determining an erroneous operation of the accelerator pedal and stably reduce the possibility of sudden acceleration of the vehicle.

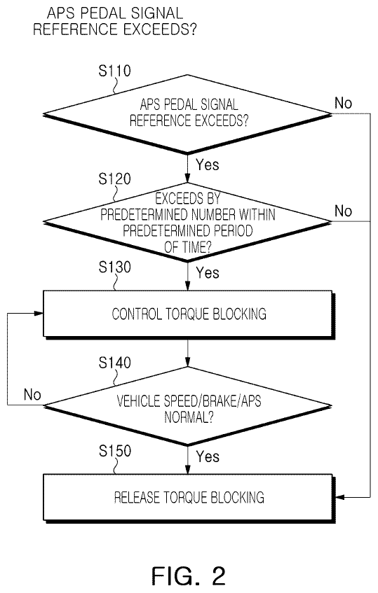

FIG. 2 is a flowchart illustrating a method for preventing erroneous operation of an accelerator pedal according to an embodiment of the present disclosure. Referring to FIGS. 1 and 2, the method for preventing erroneous operation of an accelerator pedal according to an embodiment of the present disclosure may include operations S110 and S120 of receiving an accelerator pedal signal from the accelerator pedal sensor 15 by the controller 500 and determining whether the number of over-efforts by which the accelerator pedal signal exceeds an effort corresponding to the maximum acceleration (e.g., 100% throttle opening of the engine) of the accelerator pedal PD2 is a plurality of times (e.g., twice) or more within a predetermined period of time (e.g., 3 seconds).

A situation in which the driver is likely to erroneously operate the accelerator pedal may include an emergency situation in which the driver has to step on the brake pedal urgently (e.g., a situation in which a vehicle speed is too fast or a distance to a front obstacle is too close at the time when the driver recognizes the front obstacle). In the above emergency situation, the driver may try to apply a greater force (over-effort) than the force with which the accelerator pedal is normally pressed to the brake pedal a plurality of times (e.g., twice) within the predetermined period of time (e.g., 3 seconds), and may apply an over-effort to the accelerator pedal by mistaking the accelerator pedal for the brake pedal. As a result, the vehicle may accelerate suddenly.

The method for preventing erroneous operation of an accelerator pedal may include an operation S130 of selectively controlling the vehicle to block the acceleration torque of the vehicle when the number of over-efforts is a plurality of times (e.g., twice) within the predetermined period of time (e.g., 3 seconds) by the controller 500, depending on whether the number of over-efforts is the plurality of times (e.g., twice) within the predetermined period of time (e.g., 3 seconds).

For example, if the driver accidentally applies more force than usual to the accelerator pedal even though he or she normally recognizes the accelerator pedal, the number of over-efforts may be less than the plurality of times (e.g., twice) within the predetermined period of time (e.g., 3 seconds). The controller 500 may deactivate the acceleration torque blocking control according to the over-effort, and the controller 500 may thus be prevented from misjudging that the accelerator pedal is erroneously operated.

Accordingly, the method for preventing erroneous operation of an accelerator pedal according to an embodiment of the present disclosure may more stably secure the accuracy of determining an erroneous operation of the accelerator pedal and stably reduce the possibility of sudden acceleration of the vehicle.

The method for preventing erroneous operation of an accelerator pedal may further include operations S140 and S150 of releasing, by the controller 500, the acceleration torque blocking control based on the controlling operation S130 when a first release condition in which the acceleration pedal signal is less than an effort corresponding to the maximum acceleration of the accelerator pedal (e.g., less than 100% throttle opening of the engine) and a second release condition in which a brake switch of the vehicle is in an ON state or a vehicle speed of the vehicle is less than or equal to a reference vehicle speed (e.g., 0 kph) are satisfied, after the controlling operation S130. Since the second release condition may be a condition that the vehicle is in a sufficiently safe state, the necessity of the acceleration torque blocking control based on the controlling operation S130 may be lowered when the first and second release conditions are satisfied.

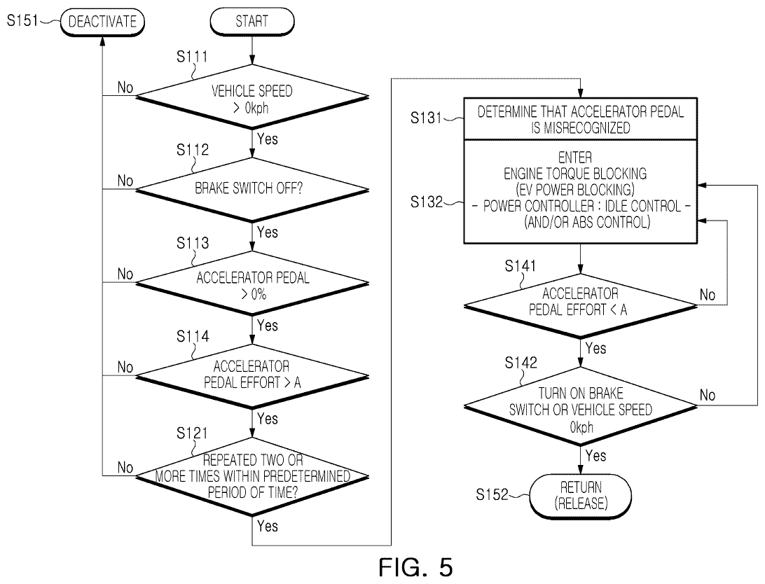

Referring to FIGS. 2 and 5, the controlling operation S130 may include an operation S112 of deactivating the acceleration torque blocking control based on the controlling operation S130 when the brake switch of the vehicle is in the ON state. The controlling operation S130 may include an operation S111 of deactivating the acceleration torque blocking control based on the controlling operation (S130) when the vehicle speed of the vehicle is lower than or equal to the reference vehicle speed (e.g., 0 kph). The deactivation may be implemented by not blocking the acceleration torque even if the accelerator pedal effort is an over-effort.

The controlling operation S130 may include an operation S132 of triggering an anti-lock braking system (ABS) of the vehicle when the number of over-efforts is a plurality of times or more within a predetermined period of time. A situation in which the driver mistakes the accelerator pedal PD1.PD2 for a brake pedal may generally be a situation in which sudden braking is required. In the controlling operation S130, the controller may not only nullify the over-effort applied to the accelerator pedal PD1, PD2, but may also produce the effect (braking effect) of the driver stepping on the brake pedal that he originally intended to step on. The ABS may be implemented by applying a plurality of braking actions to the vehicle within a short period of time and may be effective for sudden braking. For example, in the controlling operation S130, the controller may communicate with an ABS module to activate the ABS.

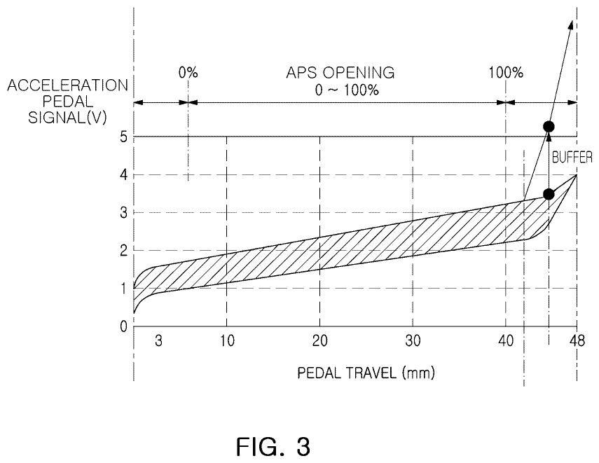

FIG. 3 is a graph illustrating a value relationship between an accelerator pedal signal of an accelerator pedal sensor and an accelerator pedal opening according to an embodiment of the present disclosure. Referring to FIGS. 1 and 3, the horizontal axis of FIG. 3 represents a distance (PEDAL TRAVEL) over which the vehicle moves as the driver's foot (FT) presses down the accelerator pedal PD1, PD2 and an APS opening (acceleration torque provided to the vehicle, throttle opening of the engine) corresponding to the distance (PEDAL TRAVEL). The vertical axis of FIG. 3 represents an accelerator pedal signal output by the accelerator pedal sensor 15 as a voltage (V).

As the distance (PEDAL TRAVEL) becomes longer, the voltage (V) of the accelerator pedal signal may become higher. The distance (PEDAL TRAVEL) may become longer as the accelerator pedal effort increases. The distance (PEDAL TRAVEL) may not exceed a maximum value (e.g., 48 mm).

Assuming that there is no buffer 13, the accelerator pedal effort (e.g., 10 kgf) corresponding to the maximum value (e.g., 48 mm) may be lower than a first reference value (e.g., 15 kgf), and the sensing of the accelerator pedal sensor 15 may be saturated (or out of the sensing range) from the accelerator pedal effort corresponding to the maximum value (e.g., 48 mm).

The buffer 13 may further increase the accelerator pedal effort corresponding to the maximum value (e.g., 48 mm) by buffering the over-effort when the APS opening (e.g., acceleration torque provided to the vehicle, throttle opening of the engine) is 100% or more, and may increase the rate of increase in the voltage (V) of the accelerator pedal signal according to the distance (PEDAL TRAVEL). Therefore, the accelerator pedal sensor 15 may stably measure the over-effort equal to or greater than the first reference value.

For example, assuming that there is no buffer 13, the accelerator pedal effort when the voltage (V) of the accelerator pedal signal is 3.5 V may be lower than the first reference value (e.g., 15 kgf). On the other hand, with the buffer 13, the accelerator pedal effort when the voltage (V) of the accelerator pedal signal is 3.5 V may be the first reference value (e.g., 15 kgf).

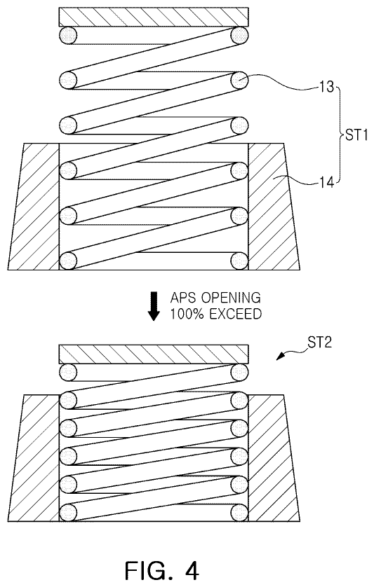

FIG. 4 is a diagram illustrating a stopper including a buffer or buffer portion of an apparatus for preventing erroneous operation of an accelerator pedal according to an embodiment of the present disclosure. Referring to FIG. 1 and FIG. 4, the apparatus for preventing erroneous operation of an accelerator pedal may include a stopper (ST: ST1, ST2), and the stopper (ST: ST1, ST2) may include the buffer 13 and a coupler or coupling portion 14.

The buffer 13 may be configured to provide elastic force in response to contact with the accelerator pedal (PD1, PD2). For example, the buffer 13 may have an elastic structure, such as a spring, or may be formed of an elastic material.

The accelerator pedal may include a pedal arm 12 and a pedal pad 11 connected to one end of the pedal arm 12. The buffer 13 may be disposed to contact the pedal arm 12 when the accelerator pedal effort is greater than or equal to a second reference value (a start value of contact between the buffer and the accelerator pedal). The pedal pad 11 may have a wide surface directly contacting the driver's foot (FT). The pedal arm 12 may be connected to the other surface of the pedal pad 11 and may extend in one direction from the other surface. Both ends of the pedal arm 12 may be connected to a portion (a fixed member based on the vehicle) of the vehicle and the pedal pad 11 (a movable member based on the vehicle), respectively. FIG. 1 illustrates an embodiment in which the structure of the accelerator pedal PD1, PD2 is a suspended pedal, but the present disclosure is not limited thereto.

The coupler 14 may be coupled to the buffer 13. For example, the coupler 14 may have a polyhedral shape with a sunken or perforated central space, and the buffer 13 may be inserted into the central space. The coupler 14 may have less elasticity than the buffer 13. The elasticity may be expressed as an elastic modulus or Young's modulus.

FIG. 5 is a flowchart illustrating an apparatus and method for preventing erroneous operation of an accelerator pedal according to an embodiment of the present disclosure. Deactivation may be implemented by not blocking the acceleration torque even if the accelerator pedal effort is an over-effort (greater than the first reference value (A)).

Referring to FIGS. 1 and 5, the controller 500 may release the acceleration torque blocking control in an operation S152 or deactivate the acceleration torque blocking control in the operation S151 according to the accelerator pedal effort when the vehicle speed of the vehicle is lower than or equal to the reference vehicle speed (e.g., 0 kph) as determining in the operation S111, S141.

The controller 500 may release the acceleration torque blocking control in the operation S152, or deactivate the acceleration torque blocking control in the operation S151 according to the accelerator pedal effort when the brake switch of the vehicle is in the ON state as determined in operation S112, S142.

The controller 500 may release the acceleration torque blocking control in the operation S152 or deactivate the acceleration torque blocking control in the operation 151 according to the accelerator pedal effort when the accelerator pedal corresponds to the minimum acceleration (e.g., 0% throttle opening of the engine) as determined in the operation S113.

The controller 500 may release the acceleration torque blocking control in the operation S152 or deactivate the acceleration torque blocking control in the operation S151 the acceleration torque blocking control according to the accelerator pedal effort when the accelerator pedal effort is less than the first reference value (A) as determined in operations S114, S141.

The controller 500 may release the acceleration torque blocking control in the operation S152 or deactivate the acceleration torque blocking control in the operation 151 according to the accelerator pedal effort when the number of over-efforts of the accelerator pedal effort higher than the first reference value (A) is less than a plurality of times (e.g., twice) within a predetermined period of time (e.g., 3 seconds) as determined in an operation S121.

The controller 500 may activate the anti-lock braking system (ABS) in an operation S132 of the vehicle when the acceleration torque is blocked, as determined in an operation S131, according to the accelerator pedal effort.

After the controller 500 blocks the acceleration torque according to the accelerator pedal effort in the operations S131, S132, if the first release condition that the accelerator pedal effort is less than the first reference value as determined in the operation S141 and the second release condition that the brake switch of the vehicle is in the ON state or the vehicle speed of the vehicle is lower than the reference vehicle speed as determined in the operation S142 are satisfied, the controller 500 may release the acceleration torque blocking control in the operation S152 according to the accelerator pedal effort.

Referring again to FIG. 1, the controller 500 of the apparatus for preventing erroneous operation of an accelerator pedal according to an embodiment of the present disclosure may be implemented as a computing system including at least one processor 501, a computer-readable storage medium or media 502, and a communication bus 503. For example, the controller 500 may be implemented as a microcontroller or an embedded system. The storage medium 502 may record one or more programs including commands for executing the method for preventing erroneous operation of an accelerator pedal according to an embodiment of the present disclosure. The communication bus 503 may interconnect other various components of the computing device, including the processor 501 and the computer-readable storage medium 502.

The processor 501 may cause the controller 500 to operate according to embodiments of the present disclosure. For example, the processor 501 may execute one or more programs stored in the computer-readable storage medium 502. The one or more programs may include one or more computer-executable instructions, which, when executed by the processor 501, may be configured to cause the controller 500 to perform operations according to the embodiment.

The computer-readable storage medium 502 may be configured to store computer-executable instructions, program code, program data, and/or other suitable forms of information. A program 502a stored on the computer-readable storage medium 502 includes a set of instructions executable by the processor 501. In an embodiment, the computer-readable storage medium 502 may include memory (volatile memory, such as random access memory, nonvolatile memory, or suitable combinations thereof), one or more magnetic disk storage devices, optical disk storage devices, flash memory devices, or other forms of storage mediums that are accessible by the controller 500 and capable of storing desired information, or suitable combinations thereof.

The controller 500 may also include one or more input/output interfaces 505 providing interfaces for one or more input/output devices 504 and one or more network communication interfaces 506. The input/output interfaces 505 and the network communication interfaces 506 are connected to a communication bus 503. The network may include a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), 5G, Wi-Fi, and/or another cellular network. The network may also be implemented as Ethernet, media oriented systems transport (MOST), Flexray, controller area network (CAN), local interconnect network (LIN), Internet, Bluetooth, near field communication (NFC), ZigBee®, radio frequency (RF), etc.

The input/output device 504 may be connected to other components of the controller 500 via the input/output interface 505. The input/output device 504 may include, for example, input devices, such as pointing devices (such as a mouse or trackpad), keyboards, touch input devices (such as a touchpad or a touchscreen), voice or sound input devices, various types of sensor devices and/or imaging devices and/or output devices, such as display devices, printers, speakers, and/or network cards. For example, the input/output device 504 may be included inside the controller 500 as a component constituting the controller 500 or may be connected to the controller 500 as a separate device distinct from the controller 500.

Embodiments of the present disclosure may include a program for performing the methods of the present disclosure on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

The apparatus, method, and storage medium for preventing erroneous operation of an accelerator pedal, and the vehicle including the same, according to embodiments of the present disclosure may more stably secure the accuracy of determining an erroneous operation of an accelerator pedal and stably reduce the possibility of sudden acceleration of the vehicle.

While embodiments have been shown and described above, it should be apparent to those having ordinary skill in the art that modifications and variations could be made without departing from the scope of the present disclosure as defined by the appended claims.

What is claimed is:

1. An apparatus for preventing erroneous operation of an accelerator pedal, the apparatus comprising:
an accelerator pedal sensor configured to sense an accelerator pedal effort of a vehicle;
a controller configured to selectively block acceleration torque of the vehicle based on determining whether the accelerator pedal effort sensed by the accelerator pedal sensor satisfies an over-effort condition in which the accelerator pedal effort sensed by the accelerator pedal sensor is higher than a first reference value; and
a buffer disposed to vary contact with the acceleration pedal based on a value relationship between a second reference value, which is lower than the first reference value, and the accelerator pedal effort, wherein the buffer is configured to buffer in response to the contact with the accelerator pedal.

2. The apparatus of claim 1, wherein the buffer is configured to provide elastic force in response to the contact with the accelerator pedal.

3. The apparatus of claim 2, further comprising a stopper including the buffer and a coupler coupled to the buffer, wherein the coupler is less elastic than the buffer.

4. The apparatus of claim 1, wherein the buffer is disposed so that the second reference value corresponds to a maximum acceleration of the accelerator pedal.

5. The apparatus of claim 1, wherein:
the accelerator pedal includes a pedal arm and a pedal pad connected to an end of the pedal arm; and
the buffer is disposed to contact the pedal arm when the accelerator pedal effort is greater than or equal to the second reference value.

6. The apparatus of claim 1, wherein the controller is configured to release or deactivate the acceleration torque blocking control according to the accelerator pedal effort based on determining that a number of times that the accelerator pedal effort is higher than the first reference value is less than a predetermined number of times within a predetermined period of time.

7. The apparatus of claim 6, wherein the controller is configured to release or deactivate the acceleration torque blocking control according to the accelerator pedal effort based on determining that a brake switch of the vehicle is in an ON state.

8. The apparatus of claim 7, wherein the controller is configured to release or deactivate the acceleration torque blocking control according to the accelerator pedal effort based on determining that a vehicle speed of the vehicle is lower than a reference vehicle speed.

9. The apparatus of claim 6, wherein the controller is configured to, after blocking the acceleration torque of the vehicle, release the acceleration torque blocking control based on determining that i) a first release condition that the accelerator pedal effort is less than the first reference value and ii) a second release condition that a brake switch of the vehicle is in an ON state or a vehicle speed of the vehicle is lower than a reference vehicle speed are satisfied.

10. The apparatus of claim 1, wherein the controller is configured to operate an anti-lock braking system (ABS) of the vehicle based on determining that the acceleration torque is blocked according to the accelerator pedal effort.

11. A method for preventing erroneous operation of an accelerator pedal of a vehicle, the method comprising:
receiving an accelerator pedal signal from an accelerator pedal sensor;
determining a number of over-effort conditions in which the accelerator pedal signal exceeds an effort corresponding to a maximum acceleration of the accelerator pedal within a predetermined period of time; and
selectively controlling the vehicle to block acceleration torque of the vehicle based on determining that the number of over-effort conditions is equal to or greater than a predetermined number of times within the predetermined period of time.

12. The method of claim 11, further comprising, after controlling the vehicle to block acceleration torque of the vehicle, releasing the acceleration torque blocking control based on determining that i) a first release condition in which the accelerator pedal signal corresponds to an effort corresponding to a maximum acceleration of the accelerator pedal and ii) a second release condition that a brake switch of the vehicle is in an ON state or when a vehicle speed of the vehicle is lower than a reference vehicle speed are satisfied.

13. The method of claim 12, wherein controlling the vehicle to block acceleration torque of the vehicle includes deactivating the acceleration torque blocking control based on determining that the brake switch of the vehicle is in the ON state.

14. The method of claim 13, wherein controlling the vehicle to block acceleration torque of the vehicle includes deactivating the acceleration torque blocking control based on determining that the vehicle speed of the vehicle is lower than a reference vehicle speed.

15. The method of claim 11, wherein controlling the vehicle to block acceleration torque of the vehicle includes operating an anti-lock braking system (ABS) of the vehicle.

16. A vehicle comprising the apparatus for preventing erroneous operation of an accelerator pedal of claim 1.

17. A nonvolatile storage medium or media storing computer-readable instructions that, when executed by a processor, cause the processor to:
receive an accelerator pedal signal from an accelerator pedal sensor configured to sense an accelerator pedal in a vehicle;
determine a number of over-effort conditions in which the accelerator pedal signal exceeds an effort corresponding to a maximum acceleration of the accelerator pedal within a predetermined period of time; and
selectively control the vehicle to block acceleration torque of the vehicle based on determining that the number of over-effort conditions is equal to or greater than a predetermined number of times within the predetermined period of time.

18. The nonvolatile storage medium or media of claim 17 storing computer-readable instructions that, when executed by the processor, further cause the processor to, after controlling the vehicle to block acceleration torque of the vehicle, release the acceleration torque blocking control based on determining that i) a first release condition in which the accelerator pedal signal corresponds to an effort corresponding to a maximum acceleration of the accelerator pedal and ii) a second release condition that a brake switch of the vehicle is in an ON state or when a vehicle speed of the vehicle is lower than a reference vehicle speed are satisfied.

19. The nonvolatile storage medium or media of claim 18 storing computer-readable instructions that, when executed by the processor, cause the processor to control the vehicle to block acceleration torque of the vehicle by deactivating the acceleration torque blocking control based on determining that the brake switch of the vehicle is in the ON state.

20. The nonvolatile storage medium or media of claim 18 storing computer-readable instructions that, when executed by the processor, cause the processor to control the vehicle to block acceleration torque of the vehicle by deactivating the acceleration torque blocking control based on determining that the vehicle speed of the vehicle is lower than the reference vehicle speed.
